(19) United States
(12) Patent Application Publication
(10) Pub. No.: US 2006/0203498 A1
(43) Pub. Date: Sep. 14, 2006

(54) Multi-colored light bulb cover

(76) Inventor: Vincent Lin, Hsin-Chu City (TW)

Correspondence Address: FITZPATRICK CELLA HARPER & SCINTO, 30 ROCKEFELLER PLAZA, NEW YORK, NY, 10112, US

(21) Appl. No.: 11/073,669

(22) Filed: Mar. 8, 2005

(51) Int. Cl. F21V 11/00

(52) U.S. Cl. 362/351; 362/252

(57) ABSTRACT

A multi-colored light bulb cover includes a transparent casing adapted to receive a light bulb therein and having a wall surface, a plurality of spaced-apart colored transparent pieces adhered to the wall surface of the casing, and a non-transparent element adhered to the wall surface of the casing around each of the colored transparent pieces.

### BACKGROUND OF THE INVENTION

1. Field of the Invention

The invention relates to a light bulb cover, more particularly to a multi-colored light bulb cover.

2. Description of the Related Art

A conventional decorative light string has light bulbs covered respectively with light bulb covers of different colors. However, since each individual light bulb cover is made to a single color, the conventional decorative light string provides limited color variety. Even if the design of each light bulb cover is varied, since each light bulb cover is monochromatic, the appearance of the conventional decorative light string is still not enhanced to a significant extent.

### SUMMARY OF THE INVENTION

Therefore, the object of the present invention is to provide a multi-colored light bulb cover that is capable of overcoming the aforementioned drawbacks of the prior art.

According to this invention, a multi-colored light bulb cover comprises a transparent casing adapted to receive a light bulb therein and having a wall surface, a plurality of spaced-apart colored transparent pieces adhered to the wall surface of the casing, and a non-transparent element adhered to the wall surface of the casing around each of the colored transparent pieces.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of the preferred embodiment of a multi-colored light bulb cover according to the present invention; and

FIG. 2 is a perspective view of the preferred embodiment in a state of use.

### DETAILED DESCRIPTION OF THE PREFERRED EMBODIMENT

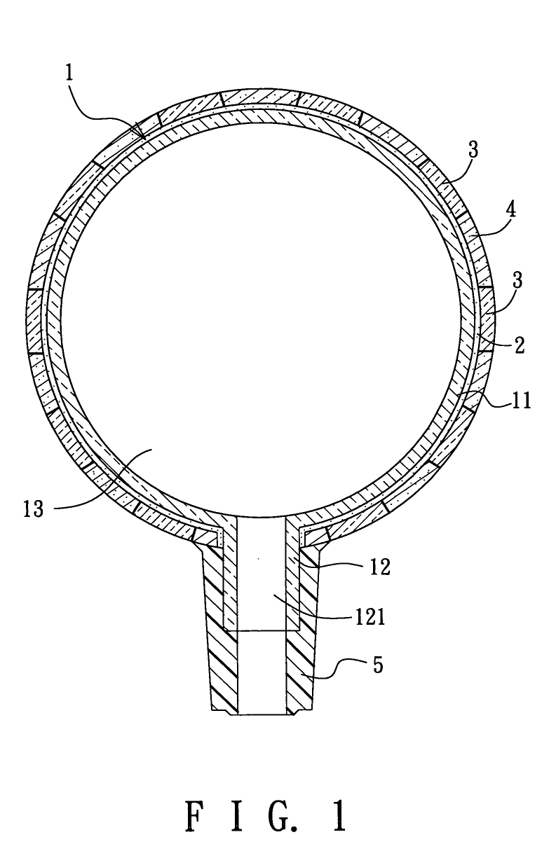

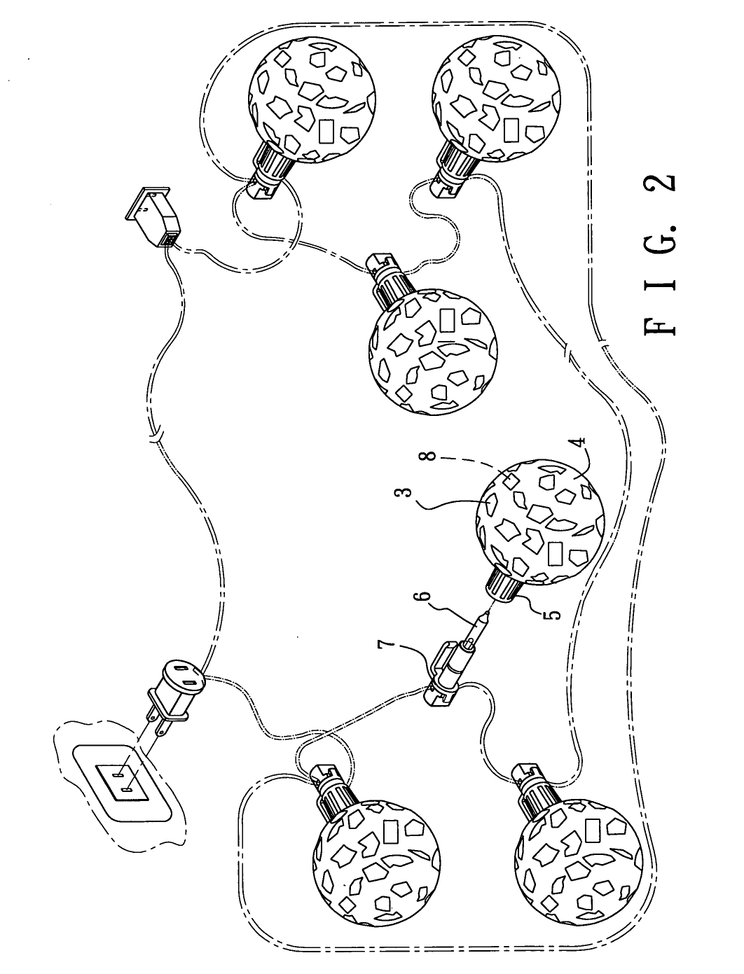

Referring to FIGS. 1 and 2, the preferred embodiment of a multi-colored light bulb cover according to the present invention is shown to comprise a transparent casing 1, a transparent adhesive layer 2, a plurality of colored transparent pieces 3, a non-transparent element 4, and a covering sleeve 5.

The transparent casing 1 is made of a glass material, and is adapted to receive a light bulb 6 therein. The transparent casing 1 includes a ball-shaped head portion 11 defining a receiving chamber 13, and a neck portion 12 extending downwardly from the head portion 11. The neck portion 12 is provided with a passage 121 that spatially communicates with the receiving chamber 13 to permit the light bulb 6 to pass therethrough and into the receiving chamber 13.

Each of the colored transparent pieces 3 is made of a colored glass material, and has an irregular shape. The colored transparent pieces 3 are adhered to an outer wall surface of the head portion 11 in a spaced apart manner. In this embodiment, each of the colored transparent pieces 3 has a curvature similar to that of the head portion 11, so that the colored transparent pieces 3 can be adhered neatly to the outer wall surface of the head portion 11, and so that no sharp ends of the colored transparent pieces 3 will protrude from the outer wall surface.

The transparent adhesive layer 2 is provided on the outer wall surface of the head portion 11. The colored transparent pieces 3 and the non-transparent element 4 are adhered to the adhesive layer 2. However, those skilled in the art will understand that it is possible to adhere the colored transparent pieces 3 to an inner wall surface of the transparent casing 1 by spin coating method or by providing a large opening for easy access to the inner wall surface of the head portion 11.

The non-transparent element 4, in this embodiment, includes a white powder. The white powder is adhered to the adhesive layer 2 around each of the colored transparent pieces 3 after the colored transparent pieces 3 are adhered to the outer wall surface of the casing 1. The thickness built up by the white powder attached to the adhesive layer 2 is able to compensate for indentations formed between the colored transparent pieces 3 so that the transparent casing 1 has a substantially even outer wall surface.

The covering sleeve 5 is sleeved on the neck portion 12 of the transparent casing 1, and has a through hole in spatial communication with the passage 121 and the receiving chamber 13.

To form a decorative light string as shown in FIG. 2, a plurality of the multi-colored light bulb covers of the present invention are respectively sleeved on a plurality of assemblies of light bulbs 6 and lamp seats 7. Each of the light bulbs 6 passes through the corresponding covering sleeve 5, the passage 121 in the neck portion 12 of the corresponding transparent casing 1, and into the receiving chamber 13 of the corresponding transparent casing 1. Each of the lamp seats 7 is inserted tightly into the corresponding covering sleeve 5. When each light bulb 6 operates to emit light rays, these light rays pass through the colored transparent pieces 3 so that a variety of colors are emanated from the transparent casing 1, thereby enhancing the appearance of the decorative light string.

From the aforementioned description of the preferred embodiment, it is apparent that the outer wall surface of the head portion 11 of the transparent casing 1 is adhered with the colored transparent pieces 3 through the transparent adhesive layer 2, and the non-transparent element 4 is adhered to the outer wall surface of the head portion 11 around each colored transparent piece 3. When the light bulb 6, which is received in the receiving chamber 13, operates to emit light rays, a variety of colors emit out of the head portion 11 through the colored transparent pieces 3. Therefore, when a plurality of the multi-colored light bulb covers are used to form a decorative light string, the overall ornamental effect is greatly enhanced over conventional configurations.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A multi-colored light bulb cover comprising:
a transparent casing adapted to receive a light bulb therein and having a wall surface;
a plurality of spaced-apart colored transparent pieces adhered to said wall surface; and
a non-transparent element adhered to said wall surface around each of said colored transparent pieces.

2. The multi-colored light bulb cover as claimed in claim 1, further comprising a transparent adhesive layer provided on said wall surface, said colored transparent pieces and said non-transparent element being attached to said transparent adhesive layer.

3. The multi-colored light bulb cover as claimed in claim 1, wherein said colored transparent pieces are made of glass materials.

4. The multi-colored light bulb cover as claimed in claim 1, wherein said transparent casing includes a head portion defining a receiving chamber adapted to receive the light bulb therein, and a neck portion connected to said head portion and having a through hole in spatial communication with said receiving chamber.

5. The multi-colored light bulb cover as claimed in claim 4, wherein said head portion is ball-shaped.

6. The multi-colored light bulb cover as claimed in claim 2, wherein said non-transparent element includes a white powder adhered to said transparent adhesive layer.
